(19) United States
(12) Patent Application Publication
(10) Pub. No.: US 2005/0075836 A1
(43) Pub. Date: Apr. 7, 2005

(54) Forensic person tracking method and apparatus

(76) Inventor: Jason Arthur Taylor, Hyattsville, MD (US)

Correspondence Address: Technology Advancement LLC, 5901 Gallatin St., Hyattsville, MD, 20781, US

(21) Appl. No.: 10/957,999

(22) Filed: Oct. 4, 2004

Related U.S. Application Data
(60) Provisional application No. 60/508,516, filed on Oct. 3, 2003.

(51) Int. Cl. G06F 17/30

(52) U.S. Cl. 702/181

(57) ABSTRACT

This invention consists of at least one computer running software that uses a relational database connected to at least one information source providing time, locations, and other data relevant to people or events. This data is hen processed by the software to determine the probabilities of association between people and one or more related events that are under investigation thereby reducing the number of high-probability suspects that are associated with an event.

### CROSS REFERENCE TO RELATED APPLICATIONS

This application claims the benefit of provisional application filed U.S. Utility Patent Application No. 60/508516 on Oct. 3, 2003 hereby incorporated herein by reference in the entirety.

### FIELD OF INVENTION

This invention relates to a method and apparatus of tracking the people who are likely to be associated with events. More specifically it involves obtaining, storing and processing potential data of events to determine which persons had a relatively high-probability of being associated with events under investigation.

### DESCRIPTION OF RELATED ART

In the field of forensic science and law enforcement, there are several methods to determine genetically (and ‘genetically’ being one of the methods), the association of persons with events under investigation. However, most of these methods are manual in nature and dependent upon the special skills of detectives utilizing data about the event under investigation. These methods are unable to handle very large numbers of potential suspects or fully utilize “generic information resources,” to the “crime scene/s” under investigation or any existing pool of high-probability suspects. Further there exist no precise to extract high-probability suspects from a large pool of low-probability suspects using such generic data sources.

There also exist certain systems like automated vehicle tracking systems, which obtain time-dependent location of the people and the objects to which they are associated. These technologies can, for instance, assist in the recovery of stolen vehicles. Unfortunately, use of location/time data in the prior art is relatively specific and narrow. Authentication systems are also routinely used to help determine which types of access should be granted to various entities. Upon swiping a card, information unique to an individual is transmitted to a program, which references a database to determine if the card is from an authorized user. If the user is using a database or machine with access to that software, Electronic/mechanical access is granted. However, such systems are not perfect. For instance, if a card is stolen, such a system could be compromised. The present invention can reduce this possibility by combining different database systems.

Therefore, what is needed is a system and method that eliminates the discussed drawbacks present in the prior art of forensic investigation.

### SUMMARY OF THE INVENTION

This invention consists of one or more computers connected to various data sources running software that uses a relational database. The computers are connected or networked to information sources providing time, locations, and other data relevant to people or events. The software uses the data to determine the probabilities of association between people and one or more related events that are under investigation. From specific descriptive information that is known about the event/s, such as time and location, the invention uses statistical methods to compute the probabilities of association to individuals thereby reducing the number of high-probability suspects that are associated with an event.

### BRIEF DESCRIPTION OF THE DRAWINGS

The preferred embodiments of the invention will hereinafter be described in conjunction with the appended drawings provided to illustrate and not to limit the invention, wherein like designations denote like elements, and in which:

FIG. 1 is a conceptual data flow diagram of the preferred embodiment of the Invention.

FIG. 2 is a detailed data flow diagram of the preferred embodiment of the invention.

FIG. 3 is a simplified diagram of the relational database using just the camera location point (hereafter, “CLP”) data source.

FIG. 4 is a diagram of a camera location point.

FIG. 5 shows use of a traditional cellular telephone, its assigned sector, and its adjacent sectors.

FIG. 6 shows the use of voice-authenticated caller ID and the placement of a location-disclosing non-cellular telephone call.

FIG. 7 shows the use of a location-disclosing key card security system.

FIG. 8 shows a location-disclosing credit or debit card financial transaction.

FIG. 9 shows a location-disclosing E-Pass financial transaction.

FIG. 10 shows location-disclosing computer usage.

FIG. 11 shows location-disclosing cable or satellite television usage.

FIG. 12 shows a plot of derivative of the electrical energy used as a function of time for use in computing the probability that someone is home.

FIG. 13 shows use of a client-unique discount card.

FIG. 14 is a Venn diagram representing the different categories of potential suspects for the two-event scenario.

### DETAILED DESCRIPTION OF THE PREFERRED EMBODIMENTS

The invention consists of one or more computers running software using a relational database connected to at least one location-based information source.

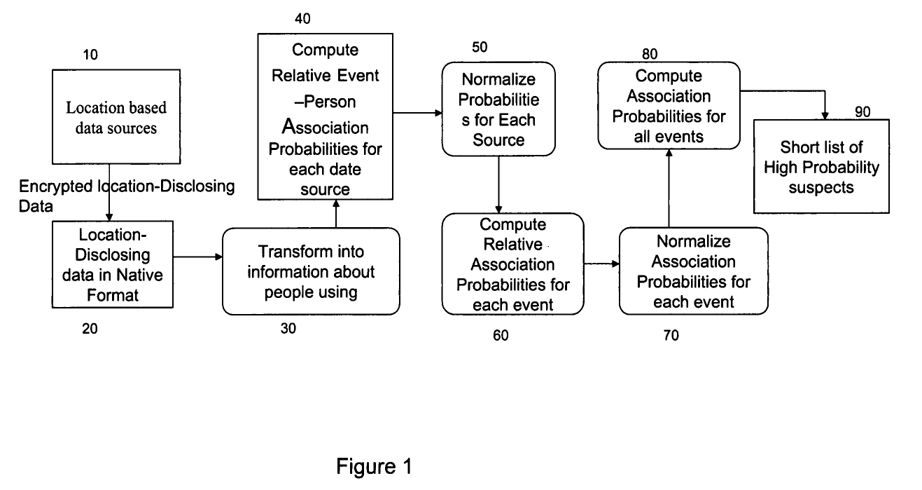

FIG. 1 is a conceptual data flow diagram for the preferred embodiment of the invention. It shows plurality of location-based data sources (10) that disclose the data in native format (20). This data is transformed into information about people (30) and computed for relative event-person association probabilities (40). Thereafter, the probabilities of each source are normalized (50) and a relative association of probabilities for each event is computed (60). Once again, there is a normalization of probabilities for each event (70) and associated probabilities for all events (80). This gives an outcome in the form of a shortlist of high probability suspects (90).

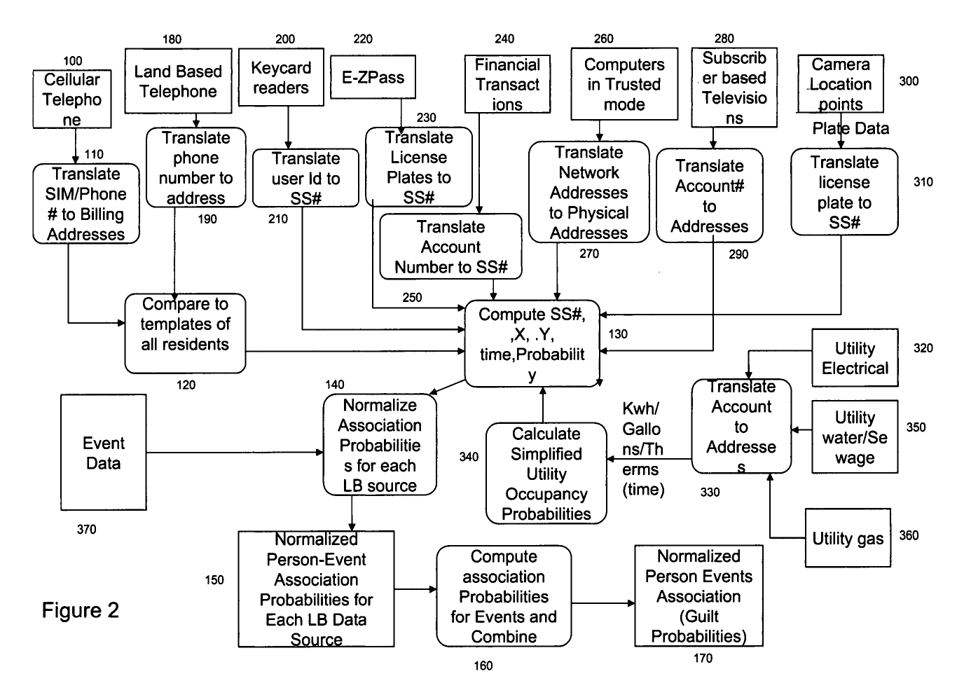

FIG. 2 is a detailed data flow diagram for the preferred embodiment of the invention. The figures shows data being received from various sources like Cellular Telephone network (100), Land Based telephone systems (180), Keycard readers (200), E-Z pass (220), Financial transaction (240), Computers in trusted mode (260), Subscriber based televisions (280), Camera Location Points (300). The data received from the above-mentioned sources gets translated (110, 190, 210, 230, 250, 270, 290, 310, 320, 350, 360) into the billing address or social security or any identification. For cellular and land based telephones (100 & 180), there will also be a comparison templates for all residents (120). For data received from Electrical (320), Water/Sewage (350) and Gas (360) a simplified utility occupancy probabilities is calculated. Thereafter, this data is computed for time and location probability (130), and normalized for each location-based source (140). Further, the data from events under investigation (370) is also normalized for location-based source (140). Person-Event association probabilities for each location based data source is normalized (150) and computed (160) to get normalized person events association (Guilt probabilities) (170).

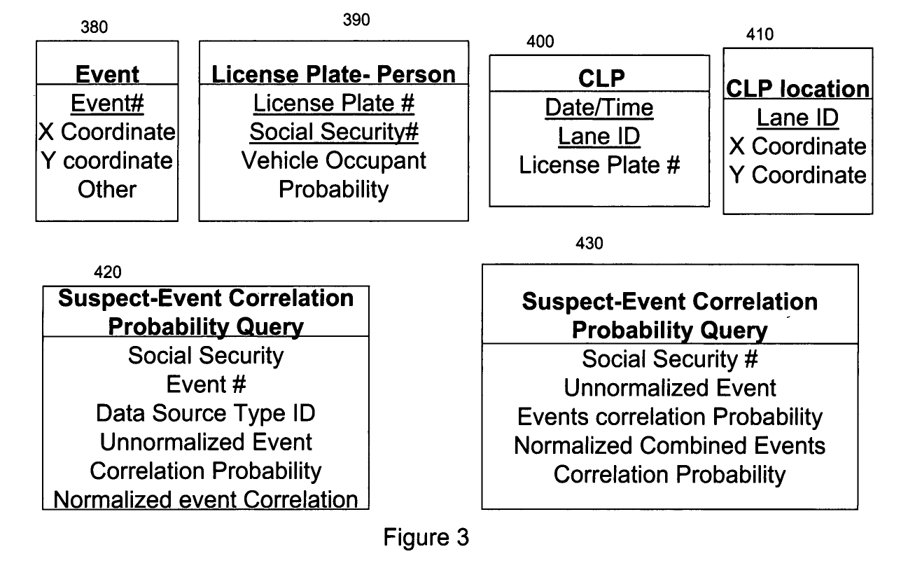

FIG. 3 shows a simplified database diagram for the portion of the relational database pertaining to the camera location point. The database software utilizes an “address-person database table” (390). The primary data source is the license plate number (400) that may be constructed from governmental department, white pages, telephone directory databases etc. Additional fields of this table are the social security number and person-license plate number vehicle occupancy probability. The person-plate occupancy probabilities are normalized (420) such that for each plate the sum of all occupancy/usage probabilities is approximately unity.

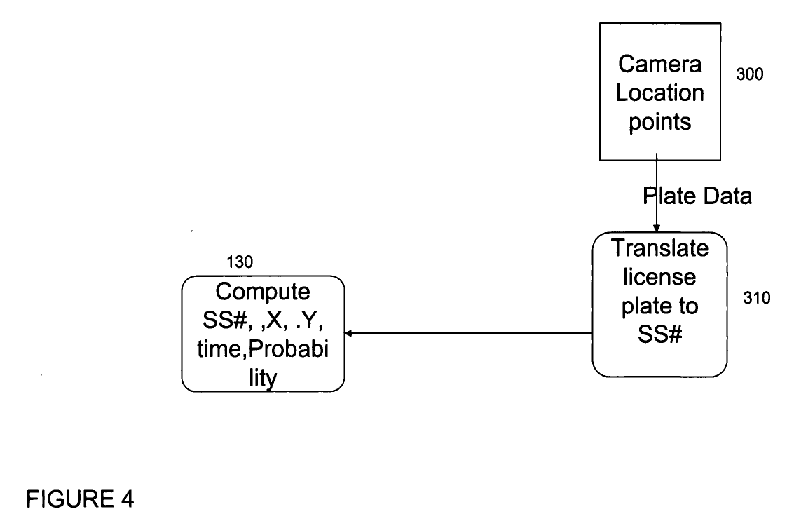

FIG. 4 shows a location-based information source that monitors vehicles. It shows a Camera Location Point (300) that monitors traffic on a major highway. Each Camera Location Point (300) consists of an array of digital cameras. Each camera is positioned appropriately for each lane of traffic being monitored. Specifically, each camera is pointed such that the back ends of the vehicles are in the camera views. In the preferred embodiment, the cameras are positioned to minimize potential obstruction from other close or large vehicles. Several Camera Location Points (300) are located at strategic locations on the major highways near the city to use the invention.

Image processing for each Camera Location Point (300) consists of obtaining an ASCII license plate data (310). This data is compressed and encrypted and transmitted via a network communication device to the central computer facility, where it is archived in a relational database. In the preferred embodiment, the ASCII license plate information for each car traversing a CLP is stored in a database, which includes the location, time, and CLP lane number. In other embodiments, additional information that may also be stored including vehicle speeds and compressed images of the front and/or rear views of the vehicles.

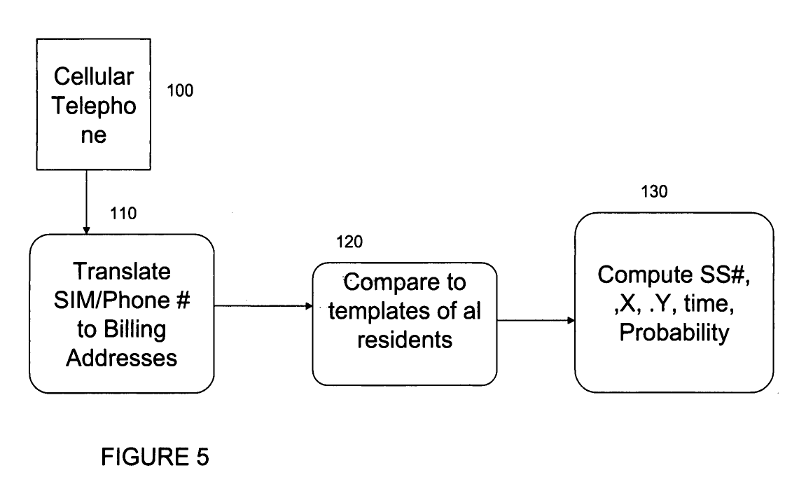

FIG. 5 shows part of a location-based information source that utilizes cellular telephone calls (100). Location-based information of all cellular telephones that are in “standby” or “on” mode in compressed and encrypted form is transmitted at regular intervals to the central computer facility. In more complex implementations of the invention, additional information, such as call origination and destination numbers are also transmitted and stored by the central relational database (130).

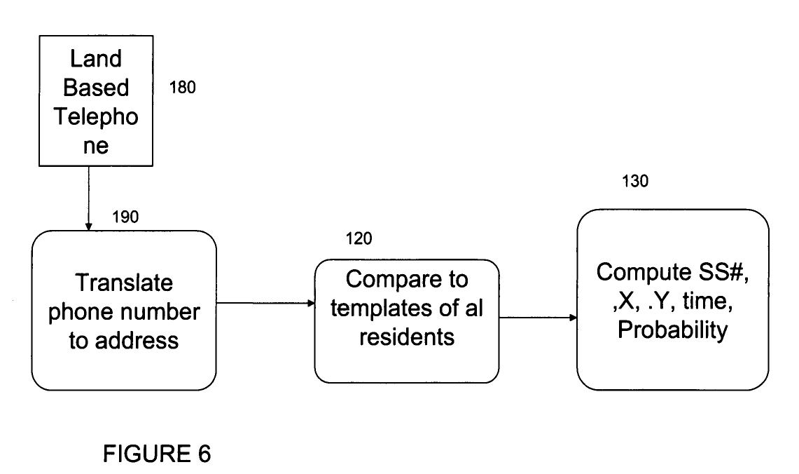

FIG. 6 shows a location-based information source that utilizes location-disclosing non-cellular telephone calls (180). Local phone companies upload call-related data with minor modifications in compressed and encrypted form to the central relational database (130).

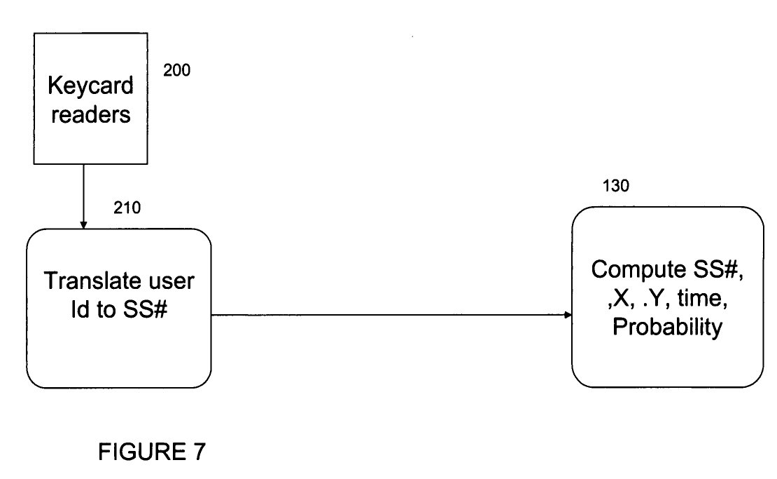

FIG. 7 shows the use of a location-disclosing key card security system (200) with minimal modifications. In this case, major companies and governmental facilities using key cards for either after-hour access or normal access transfer encrypted key card usage data to the central relational database (130).

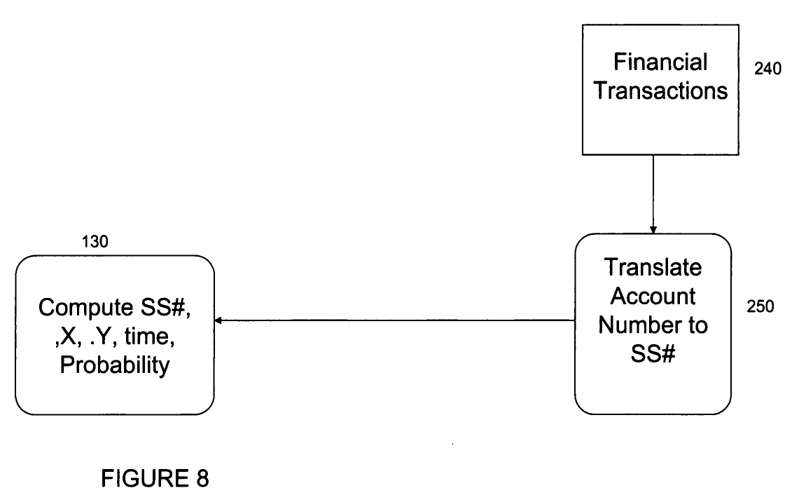

FIG. 8 shows a location-disclosing credit or debit card financial transaction (240). Financial companies transfer available financial transaction data with minor modifications to the central relational database (130). Electronic financial transactions can be further broken down into two basic categories: those in which the purchaser is present at the point of sale (“signature-authenticated transactions”) and those in which the purchaser is not present at the point of sale (“non-authenticated transactions”). The former generally can be used to obtain a relatively narrow location and time of the purchaser. On the other hand, the latter does not generally indicate the location or time, since the purchaser may be revealing credit card information over the telephone or Internet and not be physically near the point of sale. In more complex embodiments of the invention even this information is combined with other electronic location-based information, such as that from telephone calls, to increase the accuracy of and to tighten location-based association probabilities.

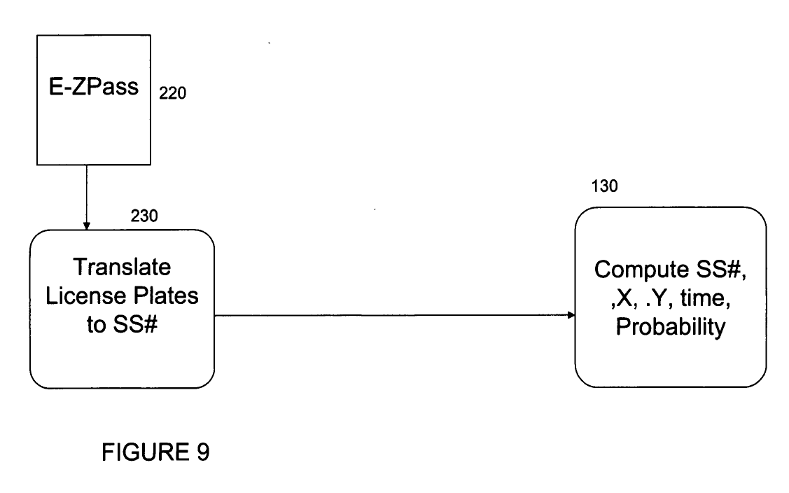

FIG. 9 shows a location-disclosing financial transaction involving motorists to pay road tolls without stopping (220). It consists of windshield-mounted vehicle-specific radio-frequency identification tags (e.g., “RF-ID”), equipment for reading the tags, computers, and a database that stores usage, identification, and billing information. The same data already required for billing and other purposes is encrypted and transmitted to the central relational database (130).

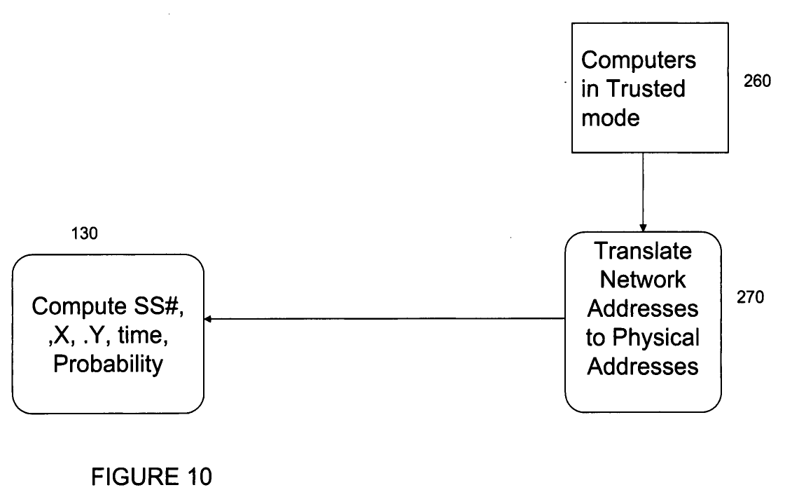

FIG. 10 shows usage of a location-disclosing computer (260). In the preferred embodiments of the invention a “logging software program” is installed on computers that request and archive the user-time information. This logging software program makes only minor modifications and additions to existing configurations, operating systems, software packages, and screen savers for the user-time information to be uploaded to the central relational database (130). Uploading of encrypted data is done periodically when the computer is online and there is new data.

There are different levels and types of logging that are done, depending on the particular embodiment of the invention that is selected. In the minimalist embodiment, the logging software merely records the users who log on and when their computers are being used. It does this by monitoring usage of peripherals such as the keyboard and mouse. In more pervasive implementations, additional logging is also performed, such as the tracking of Internet Protocol (IP) network addresses.

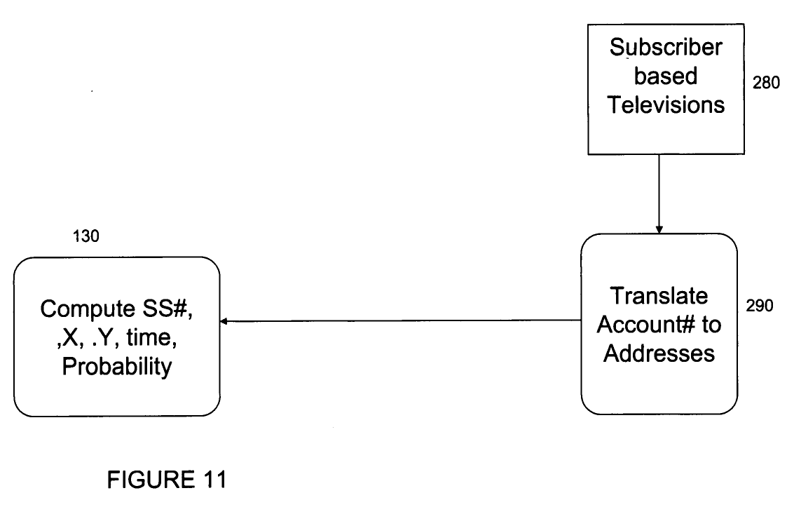

FIG. 11 shows location-disclosing cable or satellite television usage data (280). In embodiments of the invention location-disclosing cable television usage information is encrypted and uploaded to the central computer relational database (130). Periodic transmission of box-specific time usage data is uploaded to the central computer for incorporation of the central relational database. Separate periodic updates of the identity-usage probability entities are also transmitted.

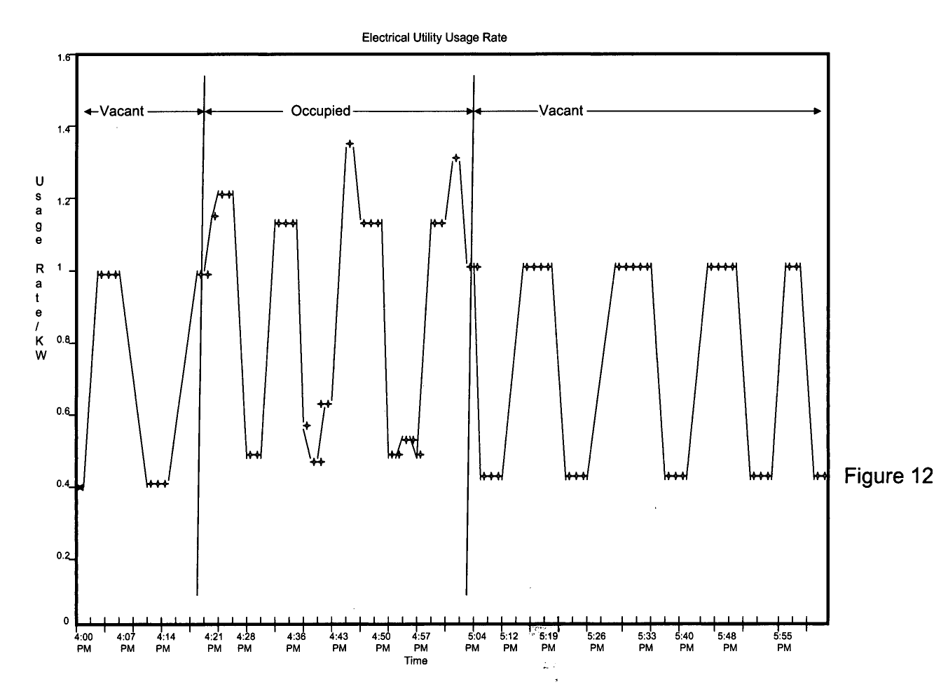

FIG. 12 shows plots of power, water, sewage, or other residential utility usage as a function of time for use in computing the probability that someone is present in a residence. There is wide adoption of automatic meter reading systems like “dumb meters with intelligent networks” and “smart meters with transparent networks.” The former type is designed with a minimum of local intelligence. It merely transmits usage data a pre-defined time period, usually 5-60 minutes, over an intelligent network, such as wireless/cellular, power lines, and telephone lines. The preferred embodiment of the invention works only with the dumb meters with intelligent network systems. Raw, high time resolution utility usage data is encrypted and transmitted to the central relation database (130) at periodic intervals.

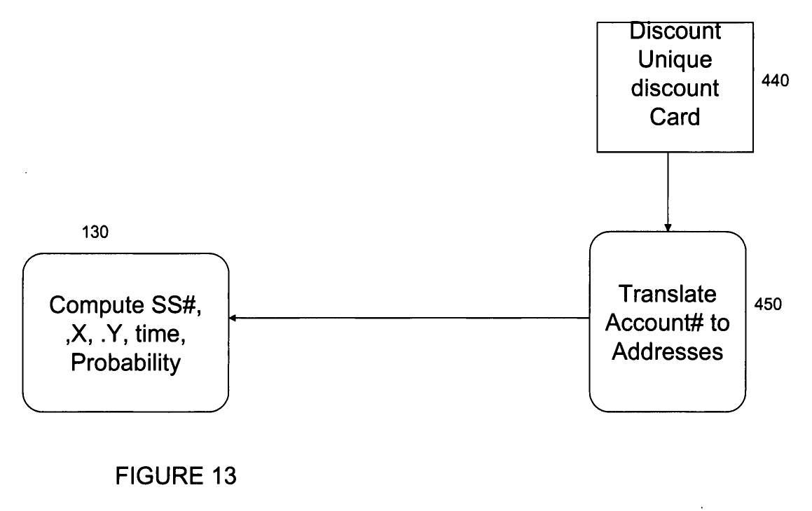

FIG. 13 shows use of a customer-unique discount card (440). Discount cards allow registered customers who use their cards to obtain reduced prices on certain items. They are also used for identity/check verification. In the preferred embodiments of the invention information from usage like the dates, times, locations, and card identification numbers of these cards is encrypted and periodically uploaded (450) to the central computer database (130).

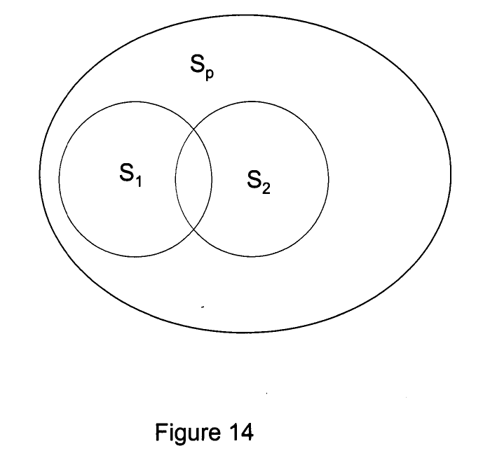

FIG. 14 is a Venn diagram representing the different categories of potential suspects for the two-event scenario. Each region corresponds to a different suspect-event correlation probabilities and license plates that were acquired near the events.

In a very simple embodiment of the invention, just one of the location-based sources is utilized, such the ASCII license plate CLP data. This license plate data is then used to obtain the probabilities that each member of a city's population is associated with one or more related events that are under investigation. This is done with two basic embodiments of the invention: theoretical and empirical. These two embodiments are described below.

The theoretical embodiment of the invention is illustrated by the following example of a potential investigation of related serial killings. Here the invention allows one to help reduce the number of suspects N_{S}, from a large number N_{P} from data set S_{P} (e.g., general population) In this example, event e.g. killing, is denoted by the integer m. License plate numbers of potential suspects are obtained by selecting database entries that correspond to locations and times that are within reasonable proximity to the event.

The number of filtered plates captured per event can be approximated as

$${N}_{m} = {\sum }_{i = 1}^{{N}_{c}} {\sum }_{j = 1}^{{N}_{Li}} {R}_{ijm} Δ {T}_{m}$$

where N_{c} and N_{Li} are the number of CLPs and lanes per CLP, respectively, Rᵢⱼₘ denotes the mean rate of plated vehicle traffic flow though CLPᵢⱼ for event m, P(Cᵢ|m) denotes the probability for CLP i and event m that all potential suspects located in the metropolitan area of the city will traverse CLP m in order to get to or depart from the location of event m. With this notation, P(Cᵢ|m) accounts for the fact that plates could be acquired both before the event and afterwards, provided he or she drove past a CLP in going to and from the site of the crime. Accurate estimates of P(Cᵢ|m) could be obtained from geographical suspect probability density distributions by combining census data with current mapping software technologies (which now provide explicit driving directions between any two points), although this is not necessary to do in a simple implementation of the invention. Typical values of Rᵢⱼₘ range from 100-2500 cars per hour. Higher values of P(Cᵢ|m) increase the chance to catch the killer.

FIG. 14 represents the tagged datasets S₁ and S₂₂ for the killing one and two, respectively. The number of “low-probability suspects” N_{S12} is represented by the total area of data sets S₁ and S₂ excluding their intersecting regions, which represent the number of “high-probability suspects” in which the same plates were near at both killings. By adding the probabilities that a killer's plate number was acquired at the CLPs nearest to each killing, one can obtain the expected number of suspects that one would find along with the respective probabilities that these suspects are guilty. If there are N_{K} killings, the number of suspects N_{SkN}_{ₖ} if acquired by exactly k CLPs can be obtained from

$$\begin{matrix}{N}_{{SkN}_{k}} = {N}_{{RkN}_{k}} + {P}_{{SkN}_{k}} , where & ( 1 ) \\ {N}_{{RkN}_{k}} ≡ {N}_{p} f ( N / {N}_{P} , k , {N}_{k} ) , & ( 2 ) \\ {P}_{{SkN}_{k}} ≡ f ( {P}_{C} , k , {N}_{k} ) , and & ( 3 ) \\ \begin{matrix}f ( x , k , {N}_{k} ) ≡ {\sum }_{{i}_{1} = 1}^{{N}_{K} - ( k - 1 )} {\sum }_{{i}_{2} = {i}_{1} + 1}^{{N}_{K} - ( k - 2 )} … {\sum }_{{i}_{k} = {i}_{k - 1} + 1}^{{N}_{K}} ( {\prod }_{l = 1}^{k} {x}_{{i}_{l}} - \\ {\sum }_{j = k + 1}^{{N}_{k}} \frac{( \begin{matrix}{N}_{k} - k \\ j - k\end{matrix} )}{( \begin{matrix}{N}_{k} \\ j\end{matrix} )} f ( x , j , {N}_{k} ) ) ,\end{matrix} & ( 4 )\end{matrix}$$

and “( )” is the choose function. The first term in equation (1) represents the expected number of suspects caught due random chance of the innocent public being at the appropriate time and place. The second term in equation (1) represents contribution to the number of suspects from the nonzero probability that the actual killer is in the kth dataset. Since the probability that the system obtains the license plate is proportional to the number of plates that are tagged, the expression for this probability is the similar to that for the number of expected suspects, but with P_{SkN}_{ₖ}/N_{SkN}_{ₖ} replaced by P_{Ci}. This second term is one of k terms contributing to the chance that the killer's identification will be obtained by the invention.

For the two-killing situation represented in FIG. 14, equations (1) to equation (4) yield

$$\begin{matrix}{N}_{S22} = {N}_{R22} + {P}_{S22} , & ( 5 ) \\ {N}_{R22} ≃ \frac{{N}_{1} {N}_{2}}{{N}_{P}} , & ( 6 ) \\ {P}_{S22} = {P}_{C1} {P}_{C2} , & ( 7 ) \\ {N}_{S12} ≃ {N}_{1} + {N}_{2} - 2 {N}_{R22} + {P}_{S12} , and & ( 8 ) \\ {P}_{S12} = {P}_{C1} + {P}_{C2} - 2 {P}_{S22} & ( 9 )\end{matrix}$$

for the number of high-probability suspects N_{S22} acquired at both of the two events and the number of expected low-probability suspects (associated with only one of the killing events) N₁₂.

For simplicity in analyzing the fundamental nature of the invention, it is instructive to consider the theoretical case in which conditions are similar for each lane and event/killing. In this case, equation (4) simplifies to

$$f ( x , k , {N}_{k} ) = ( \begin{matrix}{N}_{k} \\ k\end{matrix} ) ( {x}^{k} - {\sum }_{j = k + 1}^{{N}_{k}} \frac{( \begin{matrix}{N}_{k} - k \\ j - k\end{matrix} )}{( \begin{matrix}{N}_{k} \\ j\end{matrix} )} f ( x , j , {N}_{k} ) ) . \qquad ( 10 )$$

Conditions potentially applicable for a larger city are N_{P}≈5 million, N_{C}≈2 CLPs per event, L≈4 lanes, R≈400 cars per hour, ΔT≈1 hour, and ΣᵢP(Cᵢ|m)≈0.5≡P_{C}. These assumptions yield N_{S22}≈2.3 high-probability suspects. Thus, under these conditions, the invention reduces the number of suspects by a factor of about a million—from the population at large to a number that is indeed manageable by local law enforcement officers. However, the probability that the killer will be one of these high-probability suspects P_{S22} can be substantially less than unity. Equation (10) yields only P_{S22}≈25%.

While this probability can be increased dramatically by including other databases, such as the E-911 cellular telephone time-stamped locations, it is also increased upon each additional event or killing that is committed. For instance, if there are three killings, equation (10) yields

$${N}_{S33} ≃ {{N}_{P} ( \frac{{N}_{1}}{{N}_{P}} )}^{3} + {P}_{S33} ≃ 0.13$$

$${N}_{S23} ≃ 3 {N}_{P} [ {( \frac{{N}_{1}}{{N}_{P}} )}^{2} - \frac{{N}_{S33}}{{N}_{P}} ] + {P}_{S23} ≃ 6.5$$

$${N}_{S13} ≃ 3 {N}_{P} ( \frac{{N}_{1}}{{N}_{P}} - \frac{2 {N}_{R23}}{3 {N}_{P}} - \frac{{N}_{R33}}{{N}_{P}} ) + {P}_{S13} ≃ 9 , 588 while$$

$${P}_{S33} = {P}_{C}^{3} ≃ 13 \%$$

$${P}_{S23} = 3 ( {P}_{C}^{2} - {P}_{S33} ) ≃ 38 \%$$

$${P}_{S13} = 3 ( {P}_{C} - \frac{2}{3} {P}_{S23} - {P}_{S33} ) ≃ 38 \%$$

$${P}_{S13} + {P}_{S23} + {P}_{S33} ≃ 88 \%$$

Thus, the invention has an 88% chance of at least obtaining the identity of the killer by the third killing as one of many in the three database sets, but only with a probability of guilt as low as ≈P_{G13}≡P_{S13}/N_{S13}=0.0039%. The killer is equally likely to be in the dramatically more fruitful and manageable high-probability database for which P_{G23}=P_{S23}/N_{S23}=5.8%. The probability of guilt per identification entry for the “3-3” database is P_{G33}=P_{S33}/N_{S33}=99.0%.

If there are four similar killings,

$${N}_{S44} ≃ {{N}_{P} ( \frac{{N}_{1}}{{N}_{P}} )}^{4} + {P}_{S44} ≃ 0.06 \\ {N}_{S34} ≃ 4 {N}_{P} [ {( \frac{{N}_{1}}{{N}_{P}} )}^{3} - \frac{{N}_{S44}}{{N}_{P}} ] + {P}_{S34} ≃ 0.2552 \\ {N}_{S24} ≃ 6 {N}_{P} [ {( \frac{{N}_{1}}{{N}_{P}} )}^{2} - \frac{2 {N}_{R34}}{3 {N}_{P}} - \frac{{N}_{R44}}{{N}_{P}} ) + {P}_{S24} ≃ 11.5 \\ \begin{matrix}{N}_{S14} ≃ 4 {N}_{P} ( \frac{{N}_{1}}{{N}_{P}} - \frac{3 {N}_{S24}}{6 {N}_{P}} - \frac{3 {N}_{S34}}{4 {N}_{P}} - \frac{{N}_{S44}}{{N}_{P}} ) + \\ {P}_{S14} ≃ 12 , 776 , while\end{matrix} \\ {P}_{C44} = {P}_{C}^{4} ≃ 6.3 \% ; {P}_{G44} ≃ 100 \% \\ {P}_{C34} = 4 ( {P}_{C}^{3} - {P}_{C44} ) ≃ 25 \% ; {P}_{G34} ≃ 98 \% \\ {P}_{C24} = 6 ( {P}_{C}^{2} - \frac{2 {P}_{C34}}{4} - {P}_{C44} ) ≃ 38 \% ; {P}_{G24} ≃ 3.3 \% \\ {P}_{C14} = 4 ( {P}_{C} - \frac{3 {P}_{C24}}{6} - \frac{3 {P}_{C34}}{4} - {P}_{C44} ) ≃ 25 \% ; \\ {P}_{G14} ≃ 0.0020 \% \\ {P}_{C14} + {P}_{C24} + {P}_{C34} + {P}_{C44} ≃ 94 \% , \qquad ( 11 )$$

For this case, the invention yields a ≈94% chance that the killer will be one of the suspects in the four databases. The average probability of guilt per suspect depends upon the database selection set. The database set that has the highest guilt is the “4-4” database in which a suspect's identification information is obtained at each of the four killings. Though it is very likely that this database would be empty, the theoretical expected guilt per expected suspect approaches unity. On the other hand, the “1-1” database has a very low probability of guilt (only 0.002%), which indicates its limited utility given realistic manpower constraints of law enforcement agents. There is a ≈69% chance that the killer is one of only ≈12 (high-probability) suspects. This illustrates the ability of the invention of reducing the number of suspects involved with several linked events even when the collected data is incomplete.

In the above example of a theoretical embodiment of the invention, a fixed window in time was assumed for each CLP that was near enough to each event. This resulted in a small discreet number of possible database subset combinations (as compared to the population of the city) and a binary suspect probability function for each event. In other words, the suspect-event correlation probability time windows in the databases were step functions based on the sections of FIG. 14 they occupied. In more detailed embodiments of the invention, suspect probability correlation functions that are a complex function of time, positions, and additional information is assumed. An example of such a complex correlation function is

$${P}_{G} ( r , Δ t , i , k ) ∝ {( \frac{r}{Δ {tV}_{k}} + 1 )}^{- {β}_{k}} \qquad ( 12 )$$

where r is the distance of the suspect from the event, Δt is the absolute difference between the tag and event times, i is the social security number, k is the event identification number, and Vₖ and βₖ are event-dependent free parameters. Useful implementations employ V=50 mi hr⁻¹ and β=−1, though other values could be used as well.

In this implementation of the invention, probabilities are continuous functions rather than the discreet functions used previously. As a result, the number of different suspect probabilities is of the order of the number of potential suspects in the population. This number is much greater than the number of different camera combinations that the Venn diagrams and equations (1) to equation (11) dealt with in the previous example. For the continuous case, equation (12) is used to compute the un-normalized guilt probability for each event and member of the potential suspect database (frequently the entire city population) using an arbitrary normalization factor. These probabilities are then summed. The initial normalization factor is multiplied by one over the sum to insure that

$${\sum }_{i = 1}^{{N}_{P}} {P}_{G} ( r , t , i , k ) = 1 \qquad ( 13 )$$

for each event. Equation (13) thus provides the proportionality constant that is absent from equation (12). It replaces the estimated normalizations N_{SkN}_{ₖ} used in equations (1)-(4) with the actual number of potential suspects within a specific category of the license plate entity of the database. This has the advantage that estimates of these parameters (such as traffic densities) are not required. Note that the errors associated with this “auto-normalization” procedure are small only in situations in which the numbers involved (e.g., the number of potential suspects) are much greater than unity. Note also that equation (12) is only used for suspects in which location/time information is known using the data source being used; many potential suspects will not have location/time information for an event. The event-probability correlation for these suspects is merely a constant that is inversely proportional to the number of suspects within this category for the event. These different suspect categories correspond in many ways to the distinct regions of FIG. 14.

After the normalizations for each potential suspect of the database have been computed for the first event, the process is repeated for any additional correlated events. This ultimately yields the absolute suspect association probabilities per event for each suspect. The correlation probabilities for the combined series of all associated events is then obtained using

$${P}_{G} ( i ) = {\prod }_{k = 1}^{N} {P}_{G} ( r , t , i , k ) . \qquad ( 14 )$$

This is simply the product of the normalized event-specific probabilities for each event. In the present embodiment, equation (14) is evaluated using the SQL database language. However, other embodiments that employ these general concepts should also work.

Once the guilt-event association probabilities have been computed for each suspect of the population, the probabilities P_{C} that the invention will “catch” the killer can be computed. This is the chance that the killer's identification will be obtained by the invention. In the discreet-probability case, this function has a limited number of different values corresponding to each of the different regions in the appropriate Venn diagram. In the continuous case, P_{C} is generally continuous function of guilt probability P_{G}. As before, P_{C}(P_{G}) will generally be high for the potential suspects that are strongly linked to the event and low for others.

To compute P_{C}(P_{G}) for the more general continuous case, the database software program steps through each member of the database and adds the guilt from each suspect to obtain the cumulative guilt. This is

$${P}_{C} ( {P}_{G} ) = {\sum }_{i = 1}^{{N}_{P}} {P}_{G} ( i ) U ( {P}_{G} ( i ) - {P}_{G} ) , \qquad ( 15 )$$

where U is the step function. In an alternative, yet equivalent, implementation of the invention, the database software sorts the suspects by decreasing order of suspect-guilt probability. Instead of the step function being explicitly employed in this implementation of the invention, the summation is stopped when the suspects with a Guilt of less than PG are reached.

Generally, there are myriad location/time information sources in the relational database, each of which is represented as a separate entity in the database's logical representation. Each source provides data relevant to the locations of potential suspects that could be associated with an event. The invention uses these additional data sources to compute suspect-event association probabilities.

An example of an additional such useful data source is cellular telephone location/time information (FIG. 5). In order for the low-power, localized communications of cell phones between cell zones to operate effectively, cell phone technology resolves the locations of all cell phones in use or in standby mode (i.e., all phones that are on and not “out of area”) to within a fraction of the cell grid spacing. Moreover, in the future, once the E-911 systems have been implemented, this location/time data will be substantially more accurate. Currently, this location/time information is discarded. However, it would be relatively simple for periodic snapshots of this information to be stored in the same relational database that is used to store the license plate person-activity table.

To take advantage of this additional information, the database software (e.g., SQL) program steps through the primary keys and computes both relative and absolute normalizations in accordance with equations Error! Reference source not found for each potential suspect. For each potential suspect, the relative probabilities are computed.

One difference between the situation with the cell phone entity and that with the license plate entity concerns the types of potential suspect categories. Potential suspects who had a cell phone on or in standby mode during an event will have a unique probability function in accordance with equations (12) and (13) appropriate to cell phone time/location data. Many of these potential suspects will have a relatively low event correlation probability, especially if their cell phones localized to be far from the event position during the event. On the other hand, the potential suspects without cell phone information (probably the majority) will be in a category with a suspect-event correlation probability that is simply inversely proportional to the number of suspects within this category. This is because the total number of suspects is finite.

Before the probabilities are computed for any additional linked events, the database program and compiler process the other desired location/time data sources in the relational database, such as the license plate (CLP) source. This is done in the appropriate fashion to yield normalized source-specific probabilities that a potential suspect is associated with a particular event. These normalized different entity-specific probabilities are then multiplied together to yield the probability that an individual is correlated with a particular event. As with the situation using the simpler flat database, this process is then repeated for any additional linked events. As before, the database program then uses equation (14) to calculate the final guilt correlation probabilities for each potential suspect as well as the corresponding probability that the killer is caught by the invention P_{S}(P_{G}) with a probability of guilt of at least P_{G}. Using this procedure, a list of high-probability suspects can be obtained using several location-based sources of generic information that would otherwise be extremely difficult to take advantage of.

Computer System Requirements

The duration that data is stored is an adjustable function. Assuming that approximately 10 bytes of storage are required for each database entry number, tag, date, speed, lane, and CLP entry and a compression ratio of 4, a modern server cluster is easily capable of storing a decade of data for 40 CLPs, which permits an average of 4 CLPs for the largest 10 cities a country. Moreover, due to expected advances in storage capacities, deletion of older CLP data is an option for embodiments of the invention.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

1. A forensic person tracking system used for analyzing two or more connected events under investigation, such system comprising of:
central relation database for storing data from different sources connected to the events;
means to compute the data in the said central relation database for calculating probability of each individual being associated with such events under investigation,
so as to obtain a short list of suspects that are connected to the attributed events.

2. The tracking system of claim 1, wherein such central relation database is networked to information sources providing time and locations of the people or events.

3. The tracking system of claim 2, wherein such information of time and location includes the data from ASCII license plate of vehicles.

4. The tracking system of claim 2, wherein such information of time and location includes the data from key card security transactions.

5. The tracking system of claim 2, wherein such information of time and location includes the data from use of cellular telephone calls.

6. The tracking system of claim 2, wherein such information of time and location includes the data from a credit or debit card financial transactions.

7. The tracking system of claim 2, wherein such information of time and location includes the data from a location-disclosing computer.

8. The tracking system of claim 2, wherein such information of time and location includes the data from E-Z pass financial transaction.

9. The tracking system of claim 2, wherein such information of time and location include the data from cable or satellite television usage.

10. The tracking system of claim 2, wherein such information of time and location include the data from the use of customer-unique discount cards.

11. The tracking system of claim 2, wherein such information of time and location include the data from power, water, sewage or other residential utility usage.

12. The tracking system of claim 1, wherein the means to compute include one or more computers running software that uses relational database.

13. The tracking system of claim 12, wherein such computers are networked to information sources providing time, locations, and other data relevant to the events.

14. A method of tracking persons associated with two or more events under investigation, such method comprising the steps of:
receiving data from different sources connected to the events;
translating the said data for the purposes of storing in the central relational database; and
processing the central relational database to calculate probability of each individual being associated with such events under investigation,
so as to obtain a short list of suspects that are connected to the attributed events.

15. A method of tracking persons as claimed in claim 14, wherein the step of receiving data further comprises of providing time and locations of the people or events.

16. A method of tracking persons as claimed in claim 14, wherein the step of translating the said data comprises of compressing and encrypting the data to be stored in central relational database.
